(19) United States
(12) Patent Application Publication
(10) Pub. No.: US 2010/0226004 A1
(43) Pub. Date: Sep. 9, 2010

(54) Optical Article and Method for Producing the Same

(75) Inventors: Keiji NISHIMOTO, Ina-shi (JP); Takashi NOGUCHI, Shiojiri-shi (JP); Hiroyuki SEKI, Matsumoto-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/695,795

(22) Filed: Jan. 28, 2010

(30) Foreign Application Priority Data
Mar. 4, 2009 (JP) 2009-050323
Aug. 31, 2009 (JP) 2009-199465

(51) Int. Cl. G02B 5/20; B05D 5/06

(52) U.S. Cl. 359/359; 359/892; 427/162

(57) ABSTRACT

A method for producing an optical article having a filter layer formed directly or with another layer in between on an optical substrate, the filter layer transmitting light in a predetermined wavelength band and blocking light with a wavelength longer and/or shorter than the predetermined wavelength band, includes: forming a first layer to be included in the filter layer, and adding at least one of carbon, silicon, and germanium to the surface of the first layer, thereby reducing the resistance of the surface of the first layer.

### BACKGROUND

1. Technical Field

The present invention relates to an optical article with filtering function and a method for producing the same.

2. Related Art

JP-A-2007-298951 (Patent Document 1) discloses an optical multilayer filter capable of maintaining antistatic effect over a long period of time without degradation of optical properties and a method for producing an optical multilayer filter for easily producing such a filter. Further, for the production of an electronic device having incorporated therein such an optical multilayer filter, Patent Document 1 also discloses that, with respect to a multilayer inorganic thin film formed on the substrate of the optical multilayer filter, the density of a silicon oxide layer that forms the outermost layer of the inorganic thin film is 1.9 to 2.2 g/cm³.

According to Patent Document 1, the degree of vacuum during deposition is changed to reduce the density of the SiO₂ film forming the outermost layer, thereby reducing the sheet resistance thereof, so as to provide an optical multilayer filter having antistatic properties. However, in order to reduce the possibility of dust adhesion, further reduction in resistance is desired. As used herein, “to reduce resistance” means to reduce sheet resistance.

Use of an ITO film, which serves as a transparent electrode, in an optical article to reduce resistance has been proposed. However, in some uses, an ITO film may give concerns about durability, especially durability against sweat and like acids or alkali and like chemicals. Lamination of thin films of noble metals has also been proposed, but it may be problematic in terms of production cost.

### SUMMARY

One aspect of the invention provides a method for producing an optical article having a filter layer formed directly or with another layer in between on an optical substrate, the filter layer transmitting light in a predetermined wavelength band and blocking light with a wavelength longer and/or shorter than the predetermined wavelength band. The production method comprises forming a first layer to be included in the filter layer and adding at least one of carbon, silicon, and germanium to the surface of the first layer, thereby reducing the resistance of the surface of the first layer. Carbon, silicon, and germanium have been used as materials for household products, materials for semiconductor substrates, etc., and are available at relatively low cost. Further, the addition of these materials (composition) to the layer surface is possible by relatively simple methods, such as deposition (ion-assisted deposition), sputtering, and the like. Further, as a result of the addition to the layer surface, the layer surface is modified by the carbon, silicon, or germanium, whereby the resistance of the layer surface (surface region) can be reduced. In addition, carbon, silicon, and germanium form a compound with a transition metal, and in most cases, such compounds have low resistance. Therefore, as a result of the addition of carbon, silicon, and germanium to the surface of the first layer, accompanied by the formation of a compound in the surface region of the first layer, the resistance of the surface region can be reduced.

Further, as a result of the modification of the surface of the first layer, the influence on the optical properties of the first layer can be minimized. Even in the case where the addition of carbon, silicon, and germanium may cause a reduction in the light absorptivity of the first layer, the amount added can be adjusted to keep such reduction within the acceptable range in terms of the optical properties of the filter layer.

Therefore, this production method makes it possible to, with a minimized influence on the optical properties of the filter layer, reduce the resistivity to a level equal to or close to the case of noble metals or ITO, thereby providing an optical article having excellent antistatic effect in an economical manner.

It is preferable that the first layer is a layer containing a transition metal capable of forming a compound with at least one of carbon, silicon, and germanium. Because the composition added to reduce resistance and the composition included in the first layer form an electrically conductive composition, it is highly likely that the mechanical and/or chemical difference between the formed composition and the first layer is small, so a filter layer with mechanical and/or chemical stability can easily be manufactured.

The resistance reduction may further include adding a transition metal that forms a compound with at least one of carbon, silicon, and germanium to the surface of the first layer. Due to the formation of a compound on the surface of the first layer (surface region), possibly, the resistivity can be further reduced, and the mechanical and/or chemical stability of the surface layer can be further improved.

A typical example of the filter layer is a multilayer film including the first layer. The production method of the aspect of the invention may further include forming, on top of the first layer, other layers in the multilayer film. In the case where the composition added and the composition included in the first layer form a compound, it is highly likely that the mechanical and/or chemical difference from the other layers formed on top of the first layer can be reduced. It thus is highly likely that an optical article having a filter layer with low resistivity and more stable performance can be provided.

Another aspect of the invention provides an optical article having an optical substrate and a filter layer formed directly or with another layer in between on the optical substrate. The filter layer transmits light in a predetermined wavelength band and blocks light with a wavelength longer and/or shorter than the predetermined wavelength band. The filter layer includes a first layer having a surface region with the resistance being reduced by the addition thereto of at least one of carbon, silicon, and germanium. In the optical article, the surface region of the first layer has low resistance due to the addition thereto of at least one of carbon, silicon, and germanium. Accordingly, while suppressing the influence on the optical properties of the filter layer, antistatic effect, dust adhesion resistance, and like functions can be imparted thereto.

It is preferable that the first layer is a layer containing a transition metal capable of forming a compound with at least one of carbon, silicon, and germanium. Because the composition added to reduce resistance forms a low-resistant compound with the composition included in the first layer, there is a possibility that the mechanical and/or chemical difference between the compound formed in the surface region and the first layer can be reduced, and that an optical article having a filter layer with mechanical and/or chemical stability can be provided.

It is preferable that the surface region contains a compound of at least one of carbon, silicon, and germanium and a transition metal. In the case where a compound is formed in the surface region, it may be a compound with the composition included in the first layer, or may also be a compound with a metal that is added together with at least one of carbon, silicon, and germanium. As compared with a metal of at least one of carbon, silicon, and germanium, the compound possibly makes it possible to give even lower resistivity or higher mechanical and/or chemical stability of the surface region.

A typical example of the filter layer is one for transmitting visible light and blocking ultraviolet light and/or infrared light. The optical article may be, for example, an optical multilayer filter for use in a system for handling visible light, such as a camera or a projector. The filter layer may also be one that transmits ultraviolet light or transmits infrared light, and may alternatively be one that transmits light in a narrower wavelength band or light in a broader wavelength band.

A typical example of the filter layer is a multilayer film, and the first layer is one of the layers forming the multilayer film. Typical examples of layers forming the multilayer film are oxide layers, and the first layer is preferably an oxide layer containing a transition metal capable of forming a compound with at least one of carbon, silicon, and germanium. The filter layer may also be an organic or inorganic monolayer.

A typical example of the optical substrate is a glass plate or a quartz plate. The glass plate or the quartz plate can be used as a diaphragm, providing an optical article with oscillatory function. The optical substrate may also be a lens, a film, or the like.

Still another aspect of the invention provides a system including the optical article and an imaging apparatus for capturing an image through the optical article. One example of the system is a single-lens reflex camera with a removable lens barrel, and the optical article can be used as a cover glass of an image sensor. The optical article can also be used as a functional member, such as an antireflection film, a half mirror, or a low pass filter, and the system may be, for example, an electronic device or an optical device including such a functional member.

### BRIEF DESCRIPTION OF THE DRAWINGS

The invention will be described with reference to the accompanying drawings, wherein like numbers reference like elements.

FIG. 1 is a sectional view showing the structure of a lens including a filter layer with a multilayer structure.

FIG. 2 is a table showing the structure of a multilayer film for a UV-IR filter with a design wavelength of 550 nm.

FIG. 3 shows the transmittance of a UV-IR filter with a design wavelength of 550 nm.

FIG. 4 is a table showing evaluations for samples S1 to S4 and R1.

FIG. 5A is a sectional view showing measurement of sheet resistance, while FIG. 5B is a plan view.

FIG. 6 shows a schematic diagram of a digital single-lens reflex camera.

### DESCRIPTION OF EXEMPLARY EMBODIMENTS

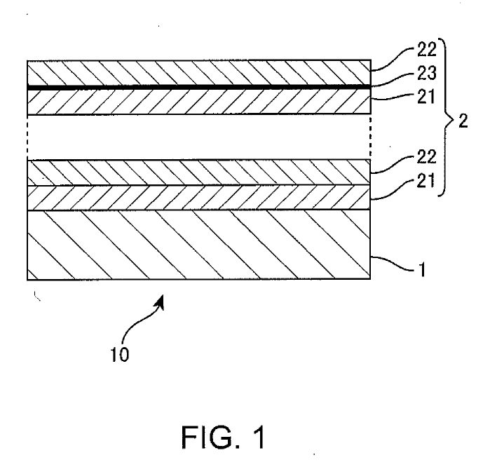

Some embodiments of the invention will be described hereinafter. FIG. 1 shows an example of the structure of an optical multilayer filter 10 according to the invention in a sectional view of one side of a substrate 1. The optical multilayer filter 10 is an example of an optical article having the light-transmissive (transparent) substrate 1 and a filter layer 2 formed directly or with another layer in between on the substrate (optical substrate) 1. The optical multilayer filter 10 shown in FIG. 1 has the filter layer 2 formed directly on the substrate 1. The filter layer 2 transmits light in a predetermined wavelength band (frequency band) and blocks light in a wavelength band (frequency band) longer and/or shorter than the predetermined wavelength band (frequency band). The filter layer 2 included in the optical multilayer filter 10 of this embodiment functions to transmit visible light and block (cut) ultraviolet rays (ultraviolet light, UV) and infrared rays (infrared light, IR).

Typically, the substrate 1 of the optical multilayer filter 10 is a plate material made of a light-transmissive material, such as glass, crystal, plastic, or the like. The substrate 1 may also be a member with specific optical properties, such as a prism or a lens made of a light-transmissive material. The substrate 1 may also be a flexible film made of a light-transmissive material.

The filter layer 2 for blocking light with a wavelength longer and/or shorter than a predetermined wavelength band is formed of a multilayer film of an inorganic composition. A typical multilayer film has a structure formed by alternately laminating a low-refractive-index layer with a refractive index of 1.3 to 1.6 and a high-refractive-index layer with a refractive index of 1.8 to 2.6. Examples of layers in the inorganic multilayer film include SiO₂, SiO, TiO₂, TiO, Ti₂O₃, Ti₂O₅, Al₂O₃, Ta₂O₂, Ta₂O₅, NdO₂, NbO, Nb₂O₃, NbO₂, Nb₂O₅, CeO₂, MgO, Y₂O₃, SnO₂, MgF₂, WO₃, HfO₂, and ZrO₂. Among these inorganic materials, each layer may be made of a single kind or a mixture of two or more kinds.

Typically, the filter layer 2 for blocking light in a wavelength band longer and/or shorter than a predetermined wavelength band is formed of a multilayer film having several dozen layers. As shown in FIG. 1, the filter layer 2 has a structure formed by combining, starting from the substrate 1 side, high-refractive-index layers (H) 21 (also referred to as TiO₂ layers 21) and low-refractive-index layers (L) 22 (also referred to as SiO₂ layers 22) to form a laminate. As the basic structure, the filter layer 2 with a design wavelength λ of 550 nm includes 60 layers. The TiO₂ layer 21 of a high-refractive-index material forming the first layer has a thickness of 0.60H, the SiO₂ layer 22 of a low-refractive-index material forming the second layer has a thickness of 0.20 L, then 1.05H, 0.37 L, (0.68H, 0.53 L)⁴, 0.69H, 0.42 L, 0.59 H, 1.92 L, (1.38H, 1.38 L)⁶, 1.48H, 1.52 L, 1.65H, 1.71 L, 1.54H, 1.59 L, 1.42H, 1.58 L, 1.51H, 1.72 L, 1.84H, 1.80 L, 1.67H, 1.77 L, (1.87H, 1.87 L)⁷, 1.89H, 1.90 L, 1.90H, and the SiO₂ layer 22 of a low-refractive-index material forming the outermost layer (the outermost surface) has a thickness of 0.96 L.

With respect to the indication of thickness, an optical film thickness nd ¼λ is defined as “1”, and the thickness of a high-refractive-index layer (H, 21) is indicated with “H”, while the thickness of a low-refractive-index layer (L, 22) is indicated with “L”. In addition, (xH, yL)^{s} means that the structure in parentheses is periodically repeated, and “S” represents the number of repetition, which is called the number of stacks.

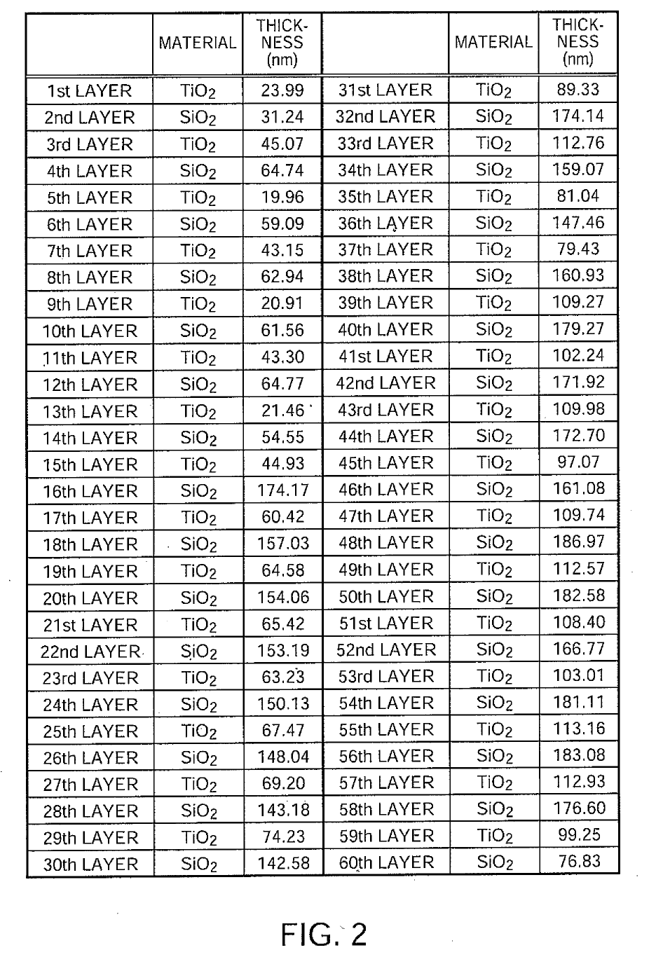

FIG. 2 shows the specific thickness of each layer in the filter layer 2 with a design wavelength λ, of 550 nm. The high-refractive-index layers 21 in the filter layer 2 are titanium oxide (TiO₂) layers, and the refractive index n thereof is 2.40. The low-refractive-index layers 22 are silicon dioxide (SiO₂) layers, and the refractive index n thereof is 1.46.

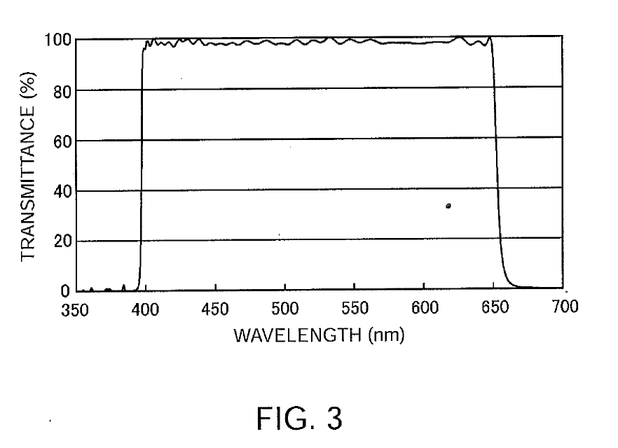

The transmittance characteristics of the optical multilayer filter 10 including the filter layer 2 are shown in FIG. 3. The optical multilayer filter 10 practically transmits light in the visible wavelength band (in this example, 390 to 660 nm), and blocks wavelengths in the shorter-wavelength ultraviolet region and the longer-wavelength red light and infrared region. The transmission characteristics of the filter layer 2 can be controlled by changing the design wavelength or changing the structure of the filter layer 2.

Examples of methods for forming the filter layer 2 include dry methods, such as vacuum deposition, ion plating, and sputtering. As vacuum deposition, ion-beam-assisted deposition may also be employed, in which an ion beam is applied simultaneously with deposition.

Further, in the optical multilayer filter 10 according to the embodiment of the invention, at least one of carbon, silicon, and germanium is added to at least one surface included in the filter layer 2, thereby reducing the resistance thereof. In the optical multilayer filter 10 shown in FIG. 1, the high-refractive-index layer 21 under the top low-refractive-index layer 22, i.e., the top high-refractive-index layer 21, has added to its surface at least one of carbon, silicon, and germanium, whereby the surface region 23 of the high-refractive-index layer 21 has reduced resistance.

Resistance reduction includes converting the surface region 23 of the layer 21, which is the subject of resistance reduction (in this example, a high-refractive-index layer), into a metal region of carbon, silicon, and germanium. It also includes converting the surface region 23 into a compound containing at least one of carbon, silicon, and germanium. In particular, in the case where the subject layer 21 contains a transition metal capable of forming a compound with at least one of carbon, silicon, and germanium, the reduction includes implanting, adding, or infusing carbon, silicon, and germanium to the surface to thereby modify the surface region 23 to a compound-containing composition region.

An example of the compound containing at least one of carbon, silicon, and germanium is a transition metal silicide (intermetallic compound) called silicide, etc. Examples of silicides include ZrSi, CoSi, WSi, MoSi, NiSi, TaSi, NdSi, Ti₃Si, Ti₅Si₃, Ti₅Si₄, TiSi, TiSi₂, Zr₃Si, Zr₂Si, Zr₅Si₃, Zr₃Si₂, Zr₅Si₄, Zr₆Si₅, ZrSi₂, Hf₂Si, Hf₅Si₃, Hf₃Si₂, Hf₄Si₃, Hf₅Si₄, HfSi, HfSi₂, V₃Si, V₅Si₃, V₅Si₄, VSi₂, Nb₄Si, Nb₃Si, Nb₅Si₃, NbSi₂, Ta_{4.5}Si, Ta₄Si, Ta₃Si, Ta₂Si, Ta₅Si₃, TaSi₂, Cr₃Si, Cr₂Si, Cr₅Si₃, Cr₃Si₂, CrSi, CrSi₂, Mo₃Si, Mo₅Si₃, Mo₃Si₂, MoSi₂, W₃Si, W₅Si₃, W₃Si₂, WSi₂, Mn₆Si, Mn₃Si, Mn₅Si₂, Mn₅Si₃, MnSi, Mn₁₁Si₁₉, Mn₄Si₇, MnSi₂, Tc₄Si, Tc₃Si, Tc₅Si₃, TcSi, TcSi₂, Re₃Si, Re₅Si₃, ReSi, ReSi₂, Fe₃Si, Fe₅Si₃, FeSi, FeSi₂, Ru₂Si, RuSi, Ru₂Si₃, OsSi, Os₂Si₃, OsSi₂, OsSi_{1.8}, OsSi₃, Co₃Si, CO₂Si, CoSi₂, Rh₂Si, Rh₅Si₃, Rh₃Si₂, RhSi, Rh₄Si₅, Rh₃Si₄, RhSi₂, Ir₃Si, Ir₂Si, Ir₃Si₂, IrSi, Ir₂Si₃, IrSi_{1.75}, IrSi₂, IrSi₃, Ni₃Si, Ni₅Si₂, Ni₂Si, Ni₃Si₂, NiSi₂, Pd₅Si, Pd₉Si₂, Pd₄Si, Pd₃Si, Pd₉Si₄, Pd₂Si, PdSi, Pt₄Si, Pt₃Si, Pt₅Si₂, Pt₁₂Si₅, Pt₇Si₃, Pt₂Si, Pt₆Si₅, and PtSi.

Another example of the compound containing at least one of carbon, silicon, and germanium is a transition metal germanide (intermetallic compound) called germanide, etc. Examples of germanides include NaGe, AlGe, KGe₄, TiGe₂, TiGe, Ti₆Ge₅, Ti₅Ge₃, V₃Ge, CrGe₂, Cr₃Ge₂, CrGe, Cr₃Ge, Cr₅Ge₃, Cr₁₁Ge₈, MnGe, Mn₅Ge₃, CoGe, CoGe₂, Co₅Ge₇, NiGe, CuGe, Cu₃Ge, ZrGe₂, ZrGe, RbGe₄, NbGe₂, Nb₂Ge, Nb₃Ge, Nb₅Ge₃, Nb₃Ge₂, NbGe₂, Mo₃Ge, Mo₃Ge₂, Mo₅Ge₃, Mo₂Ge₃, MoGe₂, CeGe₄, RhGe, PdGe, AgGe, Hf₅Ge₃, HfGe, HfGe₂, TaGe₂, and PtGe.

Still another example of the compound containing at least one of carbon, silicon, and germanium is an organic transition metal called carbide, etc. Examples of organic transition metals include SiC, TiC, ZrC, HfC, VC, NbC, TaC, Mo₂C, W₂C, WC, NdC₂, LaC₂, CeC₂, PrC₂, and SmC₂.

### Production of Optical Multilayer Filter

### Example 1

### Sample S1

The substrate 1 herein is a glass substrate for transmitting light. In Example 1, a clear glass (B270) with a refractive index of 1.53 was used. Further, a filter layer 2 of an inorganic thin film was formed on the substrate 1 by ordinary ion-assisted, electron beam deposition (so-called IAD method), giving an optical multilayer filter 10. In Example 1, high-refractive-index layers 21 in the filter layer 2 are titanium oxide (TiO₂) layers, and low-refractive-index layers 22 are silicon dioxide (SiO₂) layers. Specifically, the substrate 1 was placed in a vacuum deposition chamber (not illustrated). A crucible fined with a deposition material was then placed at the bottom of the vacuum deposition chamber, and evaporated by an electron beam. Simultaneously, ionized oxygen was accelerated and irradiated using an ion gun (Ar was added in the case of TiO₂ film formation), thereby alternately forming films to the thickness shown in FIG. 2.

The conditions for forming TiO₂ films and SiO₂ films are as follows.

### SiO₂-Film-Forming Conditions

Film formation rate: 0.8 nm/sec
Ion irradiation conditions

Accelerating voltage: 1000 V

Accelerating current: 1200 mA

O₂ flow rate: 70 sccm

Film formation temperature: 150° C.

### TiO₂-Film-Forming Conditions

Film formation rate: 0.3 nm/sec
Ion irradiation conditions

Accelerating voltage: 1000 V

Accelerating current: 1200 mA

O₂ flow rate: 60 sccm

Ar flow rate: 20 sccm

Film formation temperature: 150° C.

After the top high-refractive-index layer (the 59th layer) 21 was formed, prior to the formation of a low-refractive-index layer (the 60th layer) 22 to form the outermost layer (top layer), Si (metal silicon, silicon) was added by ion-assisted deposition using argon ions to the surface of the top high-refractive-index layer (the 59th layer) 21 in a deposition apparatus, thereby modifying the surface region 23 of the 59th layer to reduce the sheet resistance thereof. The conditions are as given below. After the resistance of the surface region 23 of the 59th layer was reduced, a low-refractive-index layer 22 forming the outermost layer (top layer) was formed as the 60th layer on the surface region 23 of the 59th layer.

### Conditions for Reducing Resistance (Sample S1)

Subject layer: TiO₂
Added composition: Silicon
Treatment time: 10 seconds
Ion irradiation conditions

Accelerating voltage: 1000 V

Accelerating current: 150 mA

Ar flow rate: 20 sccm

Treatment temperature: 150° C.

### Example 2

### Sample S2

In the same manner as in Example 1, an optical multilayer filter 10 including a filter layer 2 with the same structure as in Example 1 was produced. However, the conditions for reducing resistance are as follows.

### Conditions for Reducing Resistance (Sample S2)

Subject layer: TiO₂
Added composition: Silicon
Treatment time: 10 seconds
Ion irradiation conditions

Accelerating voltage: 500 V

Accelerating current: 150 mA

Ar flow rate: 20 sccm

Treatment temperature: 150° C.

After the filter layer 2 was formed, oxygen plasma treatment was performed. Subsequently, in a deposition apparatus, a high-molecular-weight, fluorine-containing organosilicon compound “KY-130” (trade name, manufactured by Shin-Etsu Chemical) was deposited to form an antifouling layer on the filter layer 2. Specifically, a pellet material containing the fluorine-containing organosilicon compound, as the deposition source, was heated at about 500° C. to form the antifouling layer. The deposition time was about 3 minutes.

### Example 3

### Sample S3

In the same manner as in Example 1, an optical multilayer filter 10 including a filter layer 2 with the same structure as in Example 1 was produced. However, the conditions for reducing resistance are as follows.

### Conditions for Reducing Resistance (Sample S3)

Subject layer: TiO₂
Added composition: Germanium
Treatment time: 10 seconds
Ion irradiation conditions

Accelerating voltage: 800 V

Accelerating current: 150 mA

Ar flow rate: 20 sccm

Treatment temperature: 150° C.

### Example 4

### Sample S4

In the same manner as in Example 1, an optical multilayer filter 10 including a filter layer 2 with the same structure as in Example 1 was produced. However, the conditions for reducing resistance are as follows.

### Conditions for Reducing Resistance (Sample S4)

Subject layer: TiO₂
Added composition: Germanium
Treatment time: 10 seconds
Ion irradiation conditions

Accelerating voltage: 500 V

Accelerating current: 150 mA

Ar flow rate: 20 sccm

Treatment temperature: 150° C.

### Comparative Example 1

### Sample R1

In the same manner as in Example 1, an optical multilayer filter 10 including a filter layer 2 with the same structure as in Example 1 was produced. However, resistance reduction was not performed.

### Evaluation of Samples

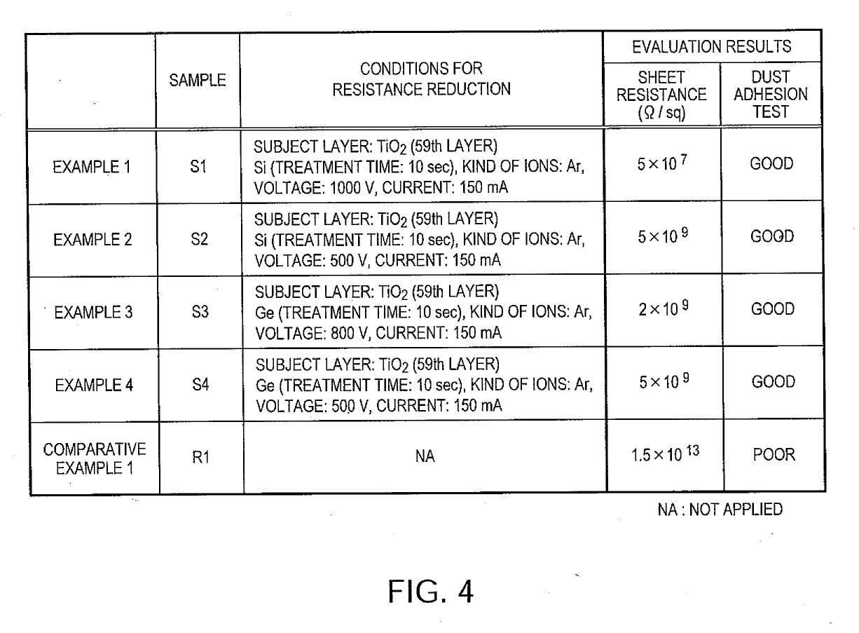

The thus-produced samples S1 to S4 and sample R1 of the Examples and Comparative Example were evaluated using sheet resistance test and dust adhesion test. The evaluation results are summarized in FIG. 4.

### (1) Sheet Resistance

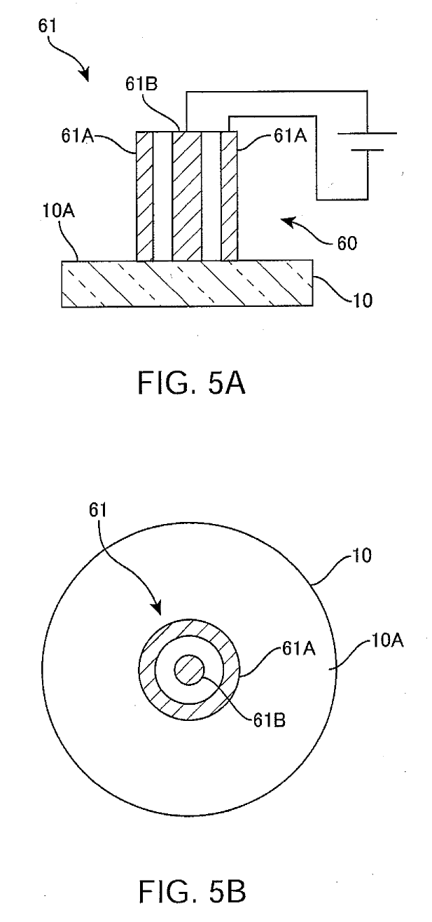

FIGS. 5A and 5B show measurement of sheet resistance. A ring probe 61 was brought into contact with the surface 10A of each of the optical multilayer filters 10 of the samples S1 to S4 and R1 produced above, thereby measuring the sheet resistance of each optical multilayer filter 10. As a measuring apparatus 60, a high-resistance resistivity meter Hiresta UP MCP-HT450 manufactured by Mitsubishi Chemical Corporation was used. The ring probe 61 used is a URS probe and has two electrodes. The exterior ring electrode 61A has an outer diameter of 18 mm and an inner diameter of 10 mm, and the interior, circular electrode 61B has a diameter of 7 mm. A voltage of 1000 V to 10 V was applied between the electrodes, and the sheet resistance of each sample was measured.

FIG. 4 shows the measurement results. With respect to the samples S1 to S4, in which the surface of one of the high-refractive-index layers 21 included in the filter layer 2 has reduced resistance, the sheet resistance was each 5×10⁷ Ω/sq to 5×10⁹ Ω/sq. This is sufficiently lower than the sheet resistance of 1×10¹² Ω/sq where dust adhesion is of concern.

### (2) Dust Adhesion Test

Using the samples S1 to S4 and R1 produced above, the surface 10A of each optical multilayer filter 10 was subjected to ten double rubs with a glasses-cleaning cloth under a vertical load of 1 kg, and dust adhesion due to the thus-generated static electricity was observed. Pieces of Styrofoam broken to a size of about 5 mm were used as the dust herein. The criterion is as follows:

Good: no dust adhesion was observed,

Fair: adhesion of some dust was observed, and

Poor: adhesion of a large amount of dust was observed.

As shown in FIG. 4, the results for the samples S1 to S4 of an optical multilayer filter 10 having reduced resistance are all Good. This therefore shows that an optical multilayer filter 10 that has undergone resistance reduction has excellent antistatic effect.

### (3) Evaluation Results

The samples S1 to S4 obtained in Examples 1 to 4 have low sheet resistance, and no dust adhesion is observed. This therefore shows that as a result of the addition of silicon or germanium to the surface, an optical multilayer filter with excellent antistatic effect is provided.

Taking silicon as an example, the explanation is as follows. When Si (metal silicon) is applied to the surface of a TiO₂ layer 21, which is a high-refractive-index layer, by ion-assisted deposition with appropriate energy, a silicon region or portion is possibly produced on the surface of the TiO₂ layer 21 or in the surface vicinity, e.g., the surface region 23 having a depth of sub-nanometer to 1 nm or more. Silicon is a semiconductor, thus has low sheet resistance, and provides antistatic properties.

Further, as a result of the implantation (addition) of Si atoms to a depth of sub-nanometer to about 1 nm or more from the surface of the TiO₂ layer 21, Si is possibly mixed with TiO₂ forming the TiO₂ layer 21, causing chemical reaction.

That is, Si atoms are driven (infused) into the TiO₂ layer 21, chemically react with the TiO₂ layer, the material of the base, and thereby make a modification in the surface region 23, which is the region in the vicinity of the surface. As a result, at least partially in the surface region 23, Ti atoms in the TiO₂ layer react with the Si atoms, possibly forming a titanium silicide, a compound, such as TiSi or TiSi₂. The resistivity of titanium silicide (e.g., TiSi₂) is as low as 15 to 20 μΩ·cm (sheet resistance (20 nm) is 12 to 18 Ω/sq), so electrical conductivity can be improved, and excellent antistatic properties are provided.

Further, silicon and silicides have excellent resistance to corrosion by acid or alkali, and also have high chemical stability. In addition, because they are the same type of compositions as the SiO₂ layer 22 to be laminated onto a TiO₂ layer 21, the mechanical stability of the filter layer 2, which is a multilayer film, is hardly impaired. The other way around, it will also be possible to modify the surface region 23 of the TiO₂ layer 21 to a silicide to thereby improve adhesion with the SiO₂ layer 22.

Accordingly, as a result of the addition of silicon to the surface of the TiO₂ layer 21, a silicon or titanium silicide region, or further a titanium silicide oxide region, can be formed over the entire surface region 23 of the TiO₂ layer 21 or in localized areas. The presence of such a minute, electrically conductive region (low-resistance region) will make it possible to reduce the sheet resistance of the filter layer 2 and improve the electrical conductivity. For this reason, the layer to which silicon is added is not limited to the 59th layer of the 60 layers forming the filter layer 2, and may be any layer. Further, even when silicon is implanted to a plurality of layer surfaces, the same result is expected.

The method for implanting silicon is not limited to ion-assisted deposition, and other methods including ordinary vacuum deposition, ion plating, sputtering, and the like can possibly be used for introducing and mixing silicon, thereby reducing the resistance of the filter layer 2 and improving antistatic properties.

Further, in this method, simply by implanting silicon and thereby modifying the portion having a depth of sub-nanometer to about 1 nm, or of several nanometers, from the surface of the TiO₂ layer 21, the resistance can be reduced to a level where sufficient antistatic properties are provided. Therefore, even in the case where a composition modified or formed by silicon implantation has high light absorptivity, the light absorption by the surface region 23 or the like can be kept to a level that has little influence on the optical properties of the optical multilayer filter 10. Further, because the surface region 23 to be modified by silicon implantation is extremely thin, and it has little influence on the optical prosperities, there will be no need for change in the film design of the filter layer 2.

This also applies to the reduction in resistance when germanium and carbon are implanted in place of silicon. Instead of implanting only silicon, germanium, and carbon, a mixture of these may also be implanted. Further, together therewith, it is also possible to implant a transition metal that forms a silicide or like compound with these metals. Like silicon, germanium and carbon are elements of group IV. They have the same electronic structure, and are located above and under silicon in the periodic table. Further, germanium and carbon are simple substances and have low sheet resistance like silicon, and also, as silicon, they form a low-resistance compound with a transition metal. Accordingly, the resistance of the surface region 23 can be reduced by implanting germanium or carbon in place of silicon, thereby providing an optical multilayer filter that is chemically and mechanically stable, has excellent antistatic properties, and suppresses dust adhesion, with almost no degradation in optical properties.

Carbon and silicon are low cost materials that are often used in household products. Germanium, as well as silicon, is also commonly used as an industrial material for semiconductor substrates and the like. Accordingly, as a result of the reduction in resistance using carbon, silicon, or germanium, an optical multilayer filter with excellent antistatic properties can be provided at low cost.

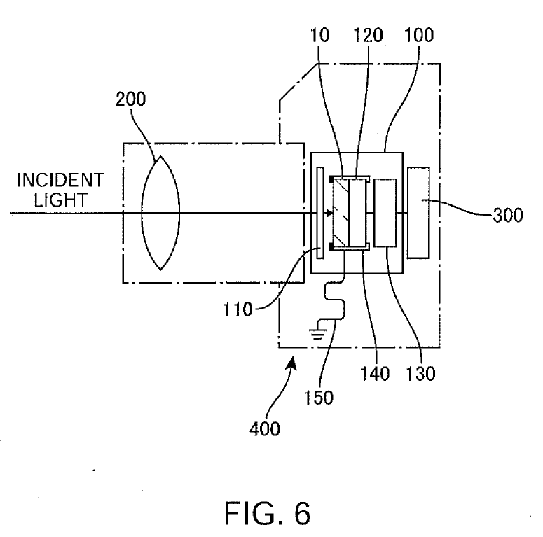

FIG. 6 shows an electronic device comprising the optical multilayer filter 10 of any of Examples 1 to 4. This is an example of application to, as an electronic device, for example, an imaging apparatus of a digital still camera with a removable lens barrel for capturing a still image. The imaging apparatus 400 of FIG. 6 includes an imaging module 100. The imaging module 100 includes the optical multilayer filter 10, an optical low pass filter 110, a CCD (charge-coupled device) 120 serving as an imaging sensor that electrically converts an optical image, and an actuator 130 that drives the CCD 120.

As explained in the Examples of the invention, the optical multilayer filter 10 has a substrate 1 and a filter layer 2 that is an inorganic thin film having alternate lamination of high-refractive-index layers 21 and low-refractive-index layers 22, and functions as a UV-IR cut filter. The optical multilayer filter 10 is placed in the front of the CCD 120 and formed integrally with the CCD 120 using a fixture jig 140, and also has the function as a dust-proof glass, which is given by the CCD 120. The fixture jig 140 is made of metal and is electrically connected to the outermost layer of the optical multilayer filter 10. The fixture jig 140 is grounded by a ground cable 150. For the purpose of dust removal, the optical multilayer filter 10 may be designed to be oscillated by a piezoelectric element, etc.

The imaging apparatus 400 includes, in addition to the imaging module 100, a lens 200 placed on the incident side and a body portion 300 that records/reproduces an image signal output from the imaging module 100 or performs like functions. In addition, although not illustrated, the body portion 300 includes a signal-processing unit that corrects an imaging signal or performs like functions, a recording unit that records an image signal on a magnetic tape or like recording media, a reproducing unit that reproduces the image signal, a displaying unit that displays the reproduced image, and like components. An example of the imaging apparatus 400 is a digital still camera with a removable lens barrel. An optical multilayer filter 10 integrally provided with a CCD 120 and having the functions as a dust-proof glass and a UV-IR cut filter is mounted thereto, whereby a digital still camera with high lamination accuracy and excellent optical characteristics can be provided. Although the imaging module 100 of the example has the structure in which the lens 200 is placed apart, the imaging module may include the lens 200.

The optical multilayer filter may be applied not only to an imaging apparatus, such as a digital still camera or a digital video camera, but also to so-called camera-equipped mobile phones, so-called camera-equipped, portable personal computers, etc., and its properties as an antistatic optical element with dust resistance and high light transmittance can be maintained. Accordingly, the invention is applicable to many systems with imaging function.

Another embodiment of the invention having a multilayer film is an optical low pass filter (OLPF). An example of the structure of OLPF is one in which a crystalline birefringent plate, an IR cut glass including a filter layer 2 with antistatic function, a phase difference film, and another crystalline birefringent plate are sequentially laminated.

Thus, the optical article according to the invention is suitable for systems that are required to selectively transmit light in different wavelength bands or secure light transmittance. The optical substrate was explained taking a clear glass as an example, but is not limited thereto. It may be a transparent substrate of BK7, sapphire glass, borosilicate glass, blue glass, SF3, SF7, or the like, and may also be a commercially available, ordinary optical glass. Further, a quartz plate as mentioned above may be used as an optical substrate, and a plastic optical substrate is also possible.

Further, the combination of a high-refractive-index layer 21 and a low-refractive-index layer 22 forming the filter layer 2 is not limited to TiO₂/SiO₂. The filter layer 2 may have various structures, including ZrO₂/SiO₂, Ta₂O₅/SiO₂, NdO₂/SiO₂, HfO₂/SiO₂, and Al₂O₃/SiO₂. Carbon, silicon, and/or germanium may be added to any of such layers for surface treatment to thereby reduce the resistance thereof and/or impart antistatic function thereto. Further, in addition to the multilayer filter layer 2, the optical article of the invention may include an additional functional layer, such as the above-mentioned antifouling layer. For example, in the case where the optical substrate is made of plastic, it may include a hard coating layer, a primer layer, and like functional layers.

What is claimed is:

1. A method for producing an optical article having a filter layer formed directly or with another layer in between on an optical substrate, the filter layer transmitting light in a predetermined wavelength band and blocking light with a wavelength longer and/or shorter than the predetermined wavelength band,
the method comprising:
forming a first layer to be included in the filter layer, and
adding at least one of carbon, silicon, and germanium to the surface of the first layer, thereby reducing the resistance of the surface of the first layer.

2. A method for producing an optical article according to claim 1, wherein the first layer contains a transition metal capable of forming a compound with at least one of carbon, silicon, and germanium.

3. A method for producing an optical article according to claim 1, wherein the reducing the resistance further includes adding a transition metal that forms a compound with at least one of carbon, silicon, and germanium to the surface of the first layer.

4. A method for producing an optical article according to claim 1, wherein the filter layer is a multilayer film including the first layer, the method further comprising forming other layers in the multilayer film on top of the first layer.

5. An optical article comprising:
an optical substrate, and
a filter layer formed directly or with another layer in between on the optical substrate, the filter layer transmitting light in a predetermined wavelength band and blocking light with a wavelength longer and/or shorter than the predetermined wavelength band,
the filter layer including a first layer containing a surface region with the resistance being reduced by the addition thereto of at least one of carbon, silicon, and germanium.

6. An optical article according to claim 5, wherein the first layer is a layer containing a transition metal capable of forming a compound with at least one of carbon, silicon, and germanium.

7. An optical article according to claim 5, wherein the surface region contains a compound of at least one of carbon, silicon, and germanium and a transition metal.

8. An optical article according to claim 5, wherein the filter layer is a filter that transmits visible light and blocks ultraviolet light and/or infrared light.

9. An optical article according to claim 5, wherein the filter layer is a multilayer film, and the first layer is one of the layers forming the multilayer film.

10. An optical article according to claim 9, wherein the first layer is an oxide layer containing a transition metal capable of forming a compound with at least one of carbon, silicon, and germanium.

11. An optical article according to claim 5, wherein the optical substrate is a glass plate or a quartz plate.

12. A system comprising:
an optical article according to claim 5, and
an imaging apparatus for capturing an image through the optical article.
